(19) United States
(12) Patent Application Publication
(10) Pub. No.: US 2005/0276881 A1
(43) Pub. Date: Dec. 15, 2005

(54) Animal food palatability enhancer and method of use and manufacture thereof

(76) Inventors: Teh-Kuei Chen, North Las Vegas, NV (US); Nayankumar B. Trivedi, Princeton, NJ (US)

Correspondence Address: CANTOR COLBURN, LLP, 55 GRIFFIN ROAD SOUTH, BLOOMFIELD, CT, 06002, US

(21) Appl. No.: 11/114,334

(22) Filed: Apr. 26, 2005

Related U.S. Application Data
(60) Provisional application No. 60/565,861, filed on Apr. 27, 2004.
(60) Provisional application No. 60/578,615, filed on Jun. 10, 2004.

(51) Int. Cl. A01K 1/00

(52) U.S. Cl. 426/2

(57) ABSTRACT

An animal food composition comprises a basal animal food composition and a catnip palatability enhancer such as catnip, catnip oil, matatabi, an extract of matatabi, nepetalactone, an active analog of nepetalactone, an active component of catnip other than nepetalactone, or a combination comprising one or more of the foregoing catnip palatability enhancers. The catnip palatability enhancer may be in the form of a flavor composition. A method of enhancing the palatability of a cat food composition comprises adding the catnip palatability enhancer to the cat food composition.

### CROSS REFERENCE TO RELATED APPLICATIONS

This application claims priority to Provisional Application Ser. No. 60/565,861, filed Apr. 27, 2004 and Ser. No.60/578,615 filed Jun. 10, 2004, which are incorporated herein by reference in their entirety.

### BACKGROUND

This disclosure relates generally to animal food, and more particularly to a palatability enhancer for animal food such as cat food.

Animal food manufacturers have a long-standing need to provide a pet food having a high degree of nutritional value, palatability, resistance to bacterial contamination and/or decomposition, and having low production costs. Each of these attributes, in various degrees, are found in the three categories of pet food: (1) canned or high moisture content products (typically greater than 50% moisture), which are usually all-meat products and which are generally more palatable to the animal; (2) dry or low moisture content products (typically, less than 15% moisture), which have the highest nutritional content, least expensive packaging, greatest convenience, but are least palatable; and (3) semi-dry or intermediate moisture content products (typically about 15% to 50% moisture), which generally have a nutritional value higher than canned food and are easier to package and more convenient to use, but may also be less palatable than canned food, but more palatable than dry food.

Dry and semi-dry products are more nutritional, easier to package, more convenient to use, and less costly to produce than canned products. However, many animals, particularly cats, are picky eaters that require a high degree of palatability. There is a continuing need, therefore, to produce more palatable dry and semi-dry pet food.

Phosphoric acid coated onto the surface of a dry cat food has been shown to be a palatability enhancer. U.S. Pat. No. 3,679,429 describes a method for improving palatability of dry cat food by coating pellets of the food with fat and one of 0.05% to 0.3% by weight hexamic acid, 0.35% to 1.0% by weight phosphoric acid, or 0.5% to 1.0% by weight citric acid. U.S. Pat. No. 3,930,031 describes improving the palatability of semi-dry and dry cat food by coating the food with a synergistic mixture of phosphoric acid and citric acid, such that the coating provides at least 0.5% by weight phosphoric acid. Also, U.S. Pat. No. 5,186,964 describes a method of increasing the palatability of dry cat food compositions by coating the cat food with a palatability enhancer that includes sodium acid pyrophosphate. One drawback of acidic palatability enhancers, however, is that application of an acid can accelerate the oxidation of fats that may be typically applied topically to dry cat foods. There thus remains a need for improved palatability enhancers for cat food and other pet foods. It would furthermore be an advantage if such enhancers did not accelerate the oxidation of fats.

### SUMMARY

In one aspect, an animal food composition comprises a catnip palatability enhancer, wherein the catnip palatability enhancer comprises nepetalactone in the form of catnip, catnip oil, matatabi, an extract of matatabi, nepetalactone, an active analog of nepetalactone, or a combination comprising one or more of the foregoing nepetalactone forms, in an amount effective to enhance the palatability of the basal animal food composition.

In another aspect, a method of increasing the palatability of a basal animal food composition comprises incorporating the above-described catnip palatability enhancer in a basal animal food composition.

In yet another aspect, a method for the manufacture of an animal food composition comprises coating a basal animal food composition with at least a portion of a catnip palatability enhancer, wherein the total amount of the catnip palatability enhancer is effective to enhance the palatability of the basal animal food composition.

In another aspect, a flavor composition for a cat food composition comprises a catnip palatability enhancer and a flavoring.

### DETAILED DESCRIPTION OF THE INVENTION

A “palatability enhancer” for animal food is an additive that provides an aroma, taste, aftertaste, mouth feel, texture, and/or organoleptic sensation that is appealing to the target animal. Palatability refers to the overall willingness of the animal to eat a certain food. In some cases, palatability enhancers may also be referred to as “flavor enhancers”.

Described herein are palatability enhancers for animal foods comprising herbs and/or extracts of herbs such as, for example, catnip that are attractants for animals. The herb may comprise active ingredients such as, for example, nepetalactone, actinidine, other animal attractants found in herbs, and combinations comprising one or more of the foregoing active ingredients.

As used herein, the term “catnip palatability enhancer” refers to a palatability enhancer comprising catnip, an active ingredient of catnip, or another herb comprising an active ingredient of catnip. In one embodiment, the catnip palatability enhancer disclosed herein includes nepetalactone in the form of catnip; catnip oil; matatabi; an extract of matatabi; nepetalactone; an active analog of nepetalactone; or a combination comprising one or more of the foregoing nepetalactone forms.

Catnip (Nepeta cateria) is a plant that is a member of the mint family of aromatic herbs. Catnip is also sometimes known as catnep, catrup, catwort, cateria, and catmint. An essential oil, catnip oil, containing the palatability enhancing component(s) of catnip, can be extracted from catnip plants. Suitable extraction processes include, for example, steam distillation, or solvent extraction. A major component of catnip oil is nepetalactone, which is a known biologically active component of catnip. As used herein, “catnip oil” accordingly refers to an extract of catnip that contains nepetalactone, its stereoisomers, and active analogs of nepetalactone; an active component of catnip other than nepetalactone; or a combination comprising one or more of the foregoing catnip palatability enhancers.

Matatabi, also known as silvervine, is a plant of the family Actinidiacaea. The matatabi plant is a deciduous plant that grown in, for example, Japan and China. Like catnip, matatabi leaves and their extracts are attractants for cats, at least in part due to the presence of nepetalactone. Matatabi powder and matatabi extracts can be formed from matatabi leaves.

Nepetalactone (C₁₀H₁₄O₂) is a cyclopentanoid monoterpene composed of two isoprene units. As used herein, the term “nepetalactone” includes all active stereoisomers of nepetalactone. Further as used herein, an “active analog” of nepetalactone is a compound having a chemical structure that is substantially similar to nepetalactone and that can function as a palatability enhancer by substantially the same mode as nepetalactone. Active analogs of nepetalactone can be naturally occurring, for example in catnip, or may be chemically synthesized. Exemplary active analogs of nepetalactone may include substituted derivatives of nepetalactone. The term “substituted”, as used herein, means that any one or more hydrogens in nepetalactone is replaced with a substituent group, provided that the designated atom's normal valence is not exceeded. Suitable substituent groups include, for example, hydroxy, C₁₋₁₈ alkyl, C₁₋₁₈ alkoxy, C₂₋₁₈ alkenyl, C₆₋₁₈ aryl, C₇₋₁₈ aralkyl, C₇₋₁₈ alkaryl, and the like. An exemplary substituted nepetalactone is dihydroxynepetalactone.

While nepetalactone is widely acknowledged as a biologically active component of catnip, other components may also contribute to the palatability-enhancing activity of catnip. Such components are referred to herein as an “active component of catnip other than nepetalactone”. Such active components, i.e., components that contribute to the palatability enhancing effect of catnip, are additional to the active analogs of nepetalactone as described above, and may or may not have a mode of action that is the same as or substantially similar to nepetalactone.

In another embodiment, the term “herbal palatability enhancer” refers to a palatability enhancer comprising an herb, an active ingredient of an herb, or a combination comprising one or more of the foregoing. Catnip palatability enhancers are a subset of herbal palatability enhancers.

In one embodiment, an herbal palatability enhancer comprises actinidine as an active ingredient. In this embodiment, the herbal palatability enhancer comprises valerian, an extract of valerian, powdered valerian, matatabi, an extract of matatabi, or a combination comprising one or more of the foregoing.

Valerian (Valeriana officinalis) is a plant that is a member of the Valerianaceae family. Among the 170 known species, common valerian (Valeriana officinalis L.) is the most widely used for medicinal purposes, although other species of valerian may be employed. Valerian roots are the subterranean part of the valerian plant. The valerian root may be prepared for extraction by grinding, chipping, or pulverizing into a powder in a hammermill, or a like instrument. Suitable extraction processes include, for example, steam distillation, or solvent extraction. One suitable process comprises extracting Valerian roots with water over a period of about 2 to about 5 hours at a temperature from about 65 to about 75° C.

The catnip or herbal palatability enhancer as described above is combined with a basal animal food composition. “Basal animal food composition” and “basal composition”, as used herein, refer to an animal food combinable with the catnip or herbal palatability enhancer. In a preferred embodiment, the animal food is formulated for cats, and includes dry cat food, canned cat food, semi-dry cat food, edible cat treats, and the like, and combinations comprising one or more of the foregoing cat foods. In addition to basal cat food compositions, the disclosed catnip and herbal palatability enhancers may also be used in other pet food compositions such as those for other companion animals such as dogs, pot-bellied pigs, and ferrets, as well as pocket animals including mice, hamsters and guinea pigs. As used herein, a basal food composition may be uncoated, or may be coated, for example, with a fat coating.

In one embodiment, the basal animal food composition is a dry pet food and/or a semi-dry pet food, formulated for cats, for example. The basal composition may comprise poultry, pork, lamb or beef by-products; vegetable protein meals; animal proteins; animal tissue or meals; grains (e.g., corn, milo, alfalfa, wheat, soy, and the like); carbohydrates; fat (e.g., tallow); minerals; vitamins; preservatives; and combinations comprising one or more of the foregoing ingredients. “By-product” refers to the non-rendered part of a carcass of a slaughtered animal, including a mammal, bird, or fish. In one embodiment, the basal composition is one that is commercially sold, and is nutritionally balanced, preferably for cats. A dry basal composition may be in bite size or pellet form of a suitable shape, such as a kibble.

The catnip or herbal palatability enhancer is combined with the basal animal food composition in a manner such that the catnip or herbal palatability enhancer is incorporated into the basal animal food composition. By incorporated it is meant that the catnip or herbal palatability enhancer is intimately associated with the basal animal food composition and does not become dissociated, for example, during normal storage conditions.

The catnip or herbal palatability enhancer is combined with the basal animal food composition in an amount effective to impart increased palatability of the food to the target animal. An insufficient amount will not enhance palatability of the basal composition, but an excessive amount may decrease the palatability of the basal composition and/or induce an unwanted response in the animal. Preferably, the amount is sufficient to enhance palatability, but less than an amount that produces undesired responses such as excitatory or unwanted playful responses. Effective amounts will also depend on the particular form of the catnip or herbal palatability enhancer used, e.g., greater amounts of catnip plant matter than either catnip oil or essentially pure nepetalactone are likely desirable. Effective amounts are readily determined by one of ordinary skill in the art without undue experimentation, particularly in view of the general guidance provided below.

In one embodiment, the catnip or herbal palatability enhancer is added during the production of the basal animal food composition so as to be dispersed in the basal composition. For example, catnip, catnip oil, matatabi, an extract of matatabi, nepetalactone, or an active analog of nepetalactone may be dispersed in the basal food composition in an amount of about 1×10⁻⁴ to about 10 weight percent of the dry weight of the basal food composition, or about 2×10⁻⁴ to about 1.5 weight percent of the dry weight of the basal food composition. Dispersion may be used for ease of processing, but may increase the amount of catnip palatability enhancer needed for effective enhancement. Thus, when provided in the form of catnip or matatabi, an effective amount of catnip palatability enhancer may be about 0.01 to about 1, or about 0.05 to about 0.5 weight percent of the total dry weight of the basal food composition. When provided in the form of catnip oil or an extract of matatabi, an effective amount of catnip palatability enhancer may be about 1×10⁻³ to about 0.1, or about 0.01 to about 0.05 weight percent of the total dry weight of the basal food composition. When provided in the form of nepetalactone, an active derivative of nepetalactone, and/or an active component of catnip other than nepetalactone, an effective amount of catnip palatability enhancer may be about 1×10⁻⁴ to about 0.01 or about 0.001 to about 0.005 weight percent of the total dry weight of the basal food composition.

The palatability enhancer may comprise an herbal palatability enhancer. When provided in the form of an herb, an effective amount of the herbal palatability enhancer may be about 0.01 to about 1, or about 0.05 to about 0.5 weight percent of the total dry weight of the basal food composition. When provided in the form of an herbal extract, an effective amount of herbal palatability enhancer may be about 1×10⁻³ to about 0.1, or about 0.01 to about 0.05 weight percent ofthe total dry weight of the basal food composition. When provided in the form of actinidine, an effective amount of herbal palatability enhancer may be about 1×10⁻⁴ to about 0.01 or about 0.001 to about 0.005 weight percent of the total dry weight of the basal food composition.

In one embodiment, the herbal palatability enhancer comprises valerian added during the production of the basal animal food composition so as to be dispersed in the basal composition. A valerian palatability enhancer may be present in an amount of less than or equal to 2 weight percent of the dry weight of the basal food composition. In one embodiment, a valerian palatability enhancer may be dispersed in the basal food composition in an amount of about 0.005 to about 1 weight percent of the dry weight of the basal food composition, or about 0.01 to about 0.1 weight percent of the dry weight of the basal food composition.

In another embodiment, the catnip or herbal palatability enhancer is deposited on the surface of the basal composition, for example in the form of a coating. Coating the basal food composition includes the topical deposition of the catnip or herbal palatability enhancer onto the surface of the basal composition, such as by spraying, dusting, and the like. The coating comprising the catnip or herbal palatability enhancer may comprise a fat or another adhesive to facilitate adhesion of the palatability enhancer to the surface of the basal food composition. It is preferred, although not required, that the catnip or herbal palatability enhancer be coated onto the basal composition uniformly or that uniform distribution of the flavor composition be achieved, for example, by repeatedly tumbling the coated food. One or more coats may be applied.

The catnip palatability enhancer may be deposited onto the surface of the basal food composition in an amount effective to provide about 1×10⁻⁵ to about to about 1 weight percent of the dry weight of the basal food composition. When provided in the form of catnip or matatabi, the amount of catnip palatability enhancer used may be about 0.001 to about 0.1, or about 0.005 to about 0.05 weight percent of the total dry weight of the basal food composition. When provided in the form of catnip oil or an extract of matatabi, the amount of catnip palatability enhancer used may be about 1×10⁻⁴ to about 0.01, or about 0.001 to about 0.005 weight percent of the total dry weight of the basal food composition. When provided in the form of nepetalactone, an active derivative of nepetalactone, and/or an active component of catnip other than nepetalactone, the amount of catnip palatability enhancer used may be about 1×10⁻⁵ to about 0.01, or about 1×10⁻⁴ to about 0.005 weight percent of the total dry weight of the basal food composition.

The palatability enhancer may comprise an herbal palatability enhancer. The herbal palatability enhancer may be deposited onto the surface of the basal food composition in an amount effective to provide about 1×10⁻⁵ to about to about 1 weight percent of the dry weight of the basal food composition. When provided in the form of an herb, the amount of herbal palatability enhancer used may be about 0.001 to about 0.1, or about 0.005 to about 0.05 weight percent of the total dry weight of the basal food composition. When provided in the form of an extract of an herb, the amount of herbal palatability enhancer used may be about 1×10⁻⁴ to about 0.01, or about 0.001 to about 0.005 weight percent of the total dry weight of the basal food composition. When provided in the form of actinidine, the amount of herbal palatability enhancer used may be about 1×10⁻⁵ to about 0.01, or about 1×10⁻⁴ to about 0.005 weight percent of the total dry weight of the basal food composition.

In one embodiment, the herbal palatability enhancer comprises valerian which may be deposited onto the surface of the basal food composition in an amount effective to provide less than 2 weight percent of the dry weight of the basal food composition as valerian palatability enhancer. In one embodiment, the valerian palatability enhancer is present at about 0.001 to about 1 weight percent of the weight of the dry weight of the basal food composition, or about 0.01 to about 0.1 weight percent of the dry weight of the basal food composition.

The catnip or herbal palatability enhancer may be both dispersed in and coated onto the basal food composition.

In still another embodiment, the catnip or herbal palatability enhancer may be formulated in the form of a flavor composition. This flavor composition may also be incorporated into the basal food composition and/or coated onto the food composition as described above. The amount of catnip or herbal palatability enhancer provided in the flavoring composition will depend on the method used to combine the flavoring composition with the basal composition and the desired final concentration. An exemplary amount of catnip or herbal palatability enhancer in the flavoring composition is about 0.0001 to about 99 weight percent, based on the total weight of the flavoring composition, i.e., the catnip or herbal palatability enhancer plus any additional flavor enhancers. In one embodiment where the flavoring composition is applied to the basal food composition as a coating, the catnip or herbal palatability enhancer comprises about 0.0001 to about 50 weight percent of the total weight of the flavor composition. In another embodiment, the catnip or herbal palatability enhancer comprises about 0.001 to about 20 weight percent of the total weight of the flavor composition, and in still another embodiment, the catnip or herbal palatability enhancer comprises about 0.001 to about 15 weight percent, or about 0.001 to about 10 weight percent of the total weight of the flavor composition.

The catnip palatability enhancer in a flavor composition may comprise catnip, catnip oil, matatabi, an extract of matatabi, nepetalactone, an active analog of nepetalactone, and/or an active component of catnip other than nepetalactone. Thus, when provided in the form of catnip or matatabi, an effective amount of catnip palatability enhancer may be about 0.01 to about 99, or about 0.1 to about 50, or about 0.1 to about 20 weight percent of the total weight of the flavor composition. When provided in the form of catnip oil or an extract of matatabi, an effective amount of catnip palatability enhancer may be about 0.01 to about 99, or about 0.005 to about 50, or about 0.05 to about 20 weight percent of the total dry weight of the flavor composition. When provided in the form of nepetalactone, an active derivative of nepetalactone, and/or an active component of catnip other than nepetalactone, an effective amount of catnip palatability enhancer may be about 0.0001 to about 99, or about 0.0005 to about 50, or about 0.002 to about 20 weight percent of the total dry weight of the flavor composition. As is known to one of skill in the art, the amount of the catnip palatability enhancer in the final animal food composition may be adjusted by increasing or decreasing the amount of the flavor composition employed.

The herbal palatability enhancer in a flavor composition may comprise valerian, an extract of valerian, powdered valerian, matatabi, an extract of matatabi, or a combination comprising one or more of the foregoing. Thus, when provided in the form of an herb such as valerian or matatabi, an effective amount of herbal palatability enhancer may be about 0.01 to about 99, or about 0.1 to about 50, or about 0.1 to about 20 weight percent of the total weight of the flavor composition. When provided in the form of an herbal extract, an effective amount of herbal palatability enhancer may be about 0.01 to about 99, or about 0.005 to about 50, or about 0.05 to about 20 weight percent of the total dry weight of the flavor composition. When provided in the form of actinidine, an effective amount of herbal palatability enhancer may be about 0.0001 to about 99, or about 0.0005 to about 50, or about 0.002 to about 20 weight percent of the total dry weight of the flavor composition. As is known to one of skill in the art, the amount of the herbal palatability enhancer in the final animal food composition may be adjusted by increasing or decreasing the amount of the flavor composition employed.

The basal food composition and/or the flavor composition may further comprise an additional palatability enhancer such as a flavoring. Suitable flavorings include, for example, a vegetable flavoring, a meat flavoring, (e.g., liver flavoring), a cheese flavoring, yeast, sodium pyrophosphate, a fat, an amino acid, a sugar, an acid phosphate, a phosphate salt, an organic acid, and/or other food or flavor ingredients utilized by the animal feed and flavor industry in order to improve palatability. Suitable meat flavorings include, for example, meat-derived flavorings (e.g., beef, pork, bacon, lamb, ham, fish, chicken, turkey, and/or other poultry flavoring) or a meat digest. A dry meat digest may be prepared by subjecting a meat by-product to proteolytic or lipolytic enzyme digestion, as is well known in the art, with reaction conditions controlled to obtain maximum flavor development. The product may then be reduced to a substantially dry form, if required.

In one exemplary method of manufacture, the basal food composition comprises a fat coating. The term “fat” refers to an edible grade fat or lipid, including fats of avian (e.g., fats derived from the tissue of chickens, turkeys, ducks, and geese), animal (e.g., animal tallow, choice white grease, lard, milk-derived fats such as butter oil, and fat typically contained in cheese), plant (e.g., coconut oil, soybean oil, and corn oil), or fats of a manufactured origin, including, but not limited to, crude or refined fats. To form a fat coating, kibbles (i.e., pellets), of the uncoated basal food composition may be placed in a convenient container for mixing, for example, a small cement mixer, tub, or coating drum. A fat, such as lard, critical animal fat, or beef tallow, may be heated to about 160° F. and sprayed onto the basal composition to provide a coating on the kibbles. The coating need not be a continuous layer, but a substantially uniform coverage of the kibble is preferred. The basal composition may be mixed during coating and for a few minutes after coating the fat to improve the uniformity of the coating. After the fat is applied, it cools quickly and may act as an imperfect barrier to other compounds (i.e., coatings) that are applied following the fat coating. At this point, a catnip or herbal palatability enhancer may be applied as either a dry powder or a liquid. A liquid palatability enhancer may, for example, be applied by spraying, while a dry product may be applied by mixing. A dry palatability enhancer may be dusted on, optionally through a mesh screen during mixing, to make the application more uniform on the kibbles.

In an alternative method of manufacture, at least a portion of the catnip or herbal palatability enhancer can be coated onto the basal composition before deposition of a fat coating and/or as part of a fat coating. For example, a catnip or herbal palatability enhancer may be dispersed in a fat and coated onto the basal composition with the fat. The palatability enhancer may be coated onto the basal composition uniformly. Uniform distribution of the palatability enhancer may be achieved, for example, by repeatedly tumbling the coated pet food during and/or after coating. One or more coats may be applied. A particular sequence of coats is not critical.

To prepare a dry catnip or herbal palatability enhancer, in an exemplary embodiment, catnip or another suitable herb may be ground into a fine powder. The powder may be combined with the food composition directly, or, for example, be dry blended with the other components of the flavor composition. Alternatively, a liquid, such as liquid catnip oil, an extract of matatabi and/or nepetalactone may be added to a sufficient amount of a starch to form a dry starch powder. The starch powder may be used directly, or dry mixed with optional additional palatability enhancers and/or flavor ingredients to form the flavor composition. Alternatively, liquid catnip oil, extract of matatabi and/or nepetalactone may be mixed with other optional palatability enhancers and/or flavorings, and spray dried to form a dry palatability enhancer or flavor composition.

To prepare a liquid catnip or herbal palatability enhancer or flavor composition, a liquid such as liquid catnip oil, extract of matatabi and/or nepetalactone and/or an active analog of nepetalactone may be mixed with corn oil or another suitable oil, and other liquid components, to form a catnip palatability enhancer composition or flavor composition. Exemplary liquid components include, for example, enzymatic digests of animal/avian meat; viscera; liver; non vegetable and vegetable protein products such as yeast, fat or lipid and their enzymatic digest or hydrolysates; amino acids; fatty acids; phosphoric acid; sodium pyrophosphate; anti oxidants; etc. Also, a suspension of dry herbal powder such as catnip powder can be formed, which may then be blended with the other liquid components of the catnip or herbal palatability enhancer or flavor composition. The dry herb powder may be suspended in another part of the flavor composition such as, for example, a liver digest.

The above-described catnip based palatability enhancers provide significant advantages over the prior art. As shown below, effective amounts of the catnip palatability enhancer can result in a consumption ratio of greater than or equal to about 1.1, more preferably greater than or equal to about 1.5. As is known in the industry, food comparisons involving animals tend to have a high degree of variability. Thus, small improvements in the consumption ratio may be significant. Use of the catnip palatability enhancers furthermore does not adversely affect the storage stability of the food composition. Naturally or organically grown catnip can be used where desired, which is an important factor to many consumers when choosing an animal food.

The invention will be further described by reference to the following examples, which are presented for the purpose of illustration only and are not intended to limit the scope of the invention. Unless otherwise indicated, all amounts are listed as parts by weight.

### EXAMPLES

The test data tabulated in the examples is derived from the industry standard two bowl comparison. In this test, each animal is presented with two bowls of food, each containing a measured amount of either the control ration or the test ration. The control and test rations contain the same or similar basal compositions. The animal is allowed to select the food it prefers. The amount of food eaten from each bowl is measured. A direct comparison of the amount eaten from the two rations gives a reliable indication of relative palatability.

For example, the cat will be given two bowls with equal amounts of food, one containing no additive or a standard additive and one containing the catnip palatability enhancer to be tested. The amount of food in the two bowls is weighed prior to giving them to the cat. During the test, steps should be taken to ensure that the cat does not finish one bowl and continue to the other because it is still hungry. This can be accomplished, for example, by limiting the time of the cat with the two bowls, or by providing enough food in each bowl to fully satisfy the cat.

At the end of the test, the two bowls are weighed again to determine the amount of food eaten from each bowl. The larger quantity is divided by the smaller quantity to provide a quantity greater than 1. If more food is eaten from the bowl with the test catnip palatability enhancer, the ratio is recorded as a positive value to indicate that the catnip palatability enhancer had a positive effect. If more food was eaten from the bowl with the control food, the ratio is recorded as a negative value to indicate that the catnip palatability enhancer did not perform as well as the control food.

For the tests, the flavor compositions were applied to a dry standard basal cat food composition. Twenty cats were fed for two days to give a total of forty choices. Multiple independent catteries were used. The bowl position was changed daily to eliminate cats that show a preference for right or left placement of the bowls. The cumulative amounts of the amounts of the two rations eaten were used to calculate the consumption ratio (C.R.). The ration with more eaten was divided by the ration with less eaten to give a ratio greater than 1. For example, a C.R. of 2 means that twice as much of one ration was eaten compared to the other ration.

Various percentages of catnip palatability enhancer in the form of a dry flavor composition were compared to the same dry flavor composition with no catnip palatability enhancer. The dry flavor composition comprises several flavor ingredients generally utilized by the pet food industry in preparation of pet food flavor enhancers. The flavor compositions were applied to a standard basal cat food composition. Comparisons A-L showing the percent of catnip in the flavor composition and the resultant consumption ratios are listed below in Table I.

TABLE I

| | Dry Flavor Composition | | |
|---|---|---|---|
| | (wt. % flavor composition | Catnip (wt. % of | |
| | coated onto a dry food | total flavor | |
| Comparison | composition) | composition) | C.R. |
| A | 1.0 | 0.01 | 1.0 |
| | 1.0 | 0 | |
| B | 1.0 | 0.1 | 1.1 |
| | 1.0 | 0 | |
| C | 1.0 | 1.0 | 1.1 |
| | 1.0 | 0 | |
| D | 1.0 | 3.0 | 1.7 |
| | 1.0 | 0 | |
| E | 1.0 | 3.0 | 1.8 |
| | 1.0 | 0 | |
| F | 1.0 | 5.0 | 1.9 |
| | 1.0 | 0 | |
| G | 1.0 | 5.0 | 1.5 |
| | 1.0 | 0 | |
| H | 1.0 | 5.0 | −1.1 |
| | 1.0 | 0 | |
| I | 1.0 | 5.0 | 1.0 |
| | 1.0 | 0 | |
| J | 1.0 | 5.0 | 1.3 |
| | 1.0 | 0 | |
| K | 1.0 | 5.0 | 4.0 |
| | 1.0 | 0 | |
| L | 1.0 | 10.0 | 2.0 |
| | 1.0 | 0 | |

Comparisons A through L show that providing a coating comprising about 0.1 weight percent to about 10.0 weight percent catnip in the flavor composition is effective in increasing the palatability of the cat food. Comparisons H, and K appear to be anomalies, with Comparison H showing a negative consumption ratio and Comparison K showing an very high consumption ratio when compared to Comparisons F-G and I-J. Overall, the compositions containing catnip give positive consumptive ratios of about 1.2 to about 2, suggesting that catnip acts as a catnip palatability enhancer for cats at the tested concentrations.

Various percentages of nepetalactone were diluted in corn oil and then blended uniformly in to different liquid and dry flavor compositions. The nepetalactone was 96% nepetalactone purchased from the KooKy Cat Catnip Company, British Columbia, Canada. The liquid and dry flavor compositions were compared to their respective control flavor composition that did not contain nepetalactone. Comparisons M-S, showing the percent of nepetalactone in the flavor composition and the resultant consumption ratio, are listed below in Table II. Examples M-Q are liquid flavor compositions, while R and S are dry flavor compositions.

TABLE II

| | Flavor Composition | | |
|---|---|---|---|
| | (wt. % of flavor | Nepetalactone | |
| | composition in dry | (wt. % of flavor | |
| Comparison | food composition) | composition) | C.R. |
| M | 2.0 | 0.00075 | −1.1 |
| | 2.0 | 0 | |
| N | 2.0 | 0.00025 | −1.1 |
| | 2.0 | 0 | |
| O | 2.0 | 0.0005 | 1.1 |
| | 2.0 | 0 | |
| P | 2.0 | 0.002 | 1.2 |
| | 2.0 | 0 | |
| Q | 2.0 | 0.003 | 1.4 |
| | 2.0 | 0 | |
| R | 1.0 | 0.05 | 1.4 |
| | 1.0 | 0 | |
| S | 1.0 | 0.05 | 2.6 |
| | 1.0 | 0 | |

Comparisons M-S show that about 0.005 weight percent nepetalactone in the flavor composition is effective in increasing the palatability of the cat food. Overall, compositions comprising nepetalactone exhibit a positive palatability effect at the concentrations tested.

Various percentages of catnip oil diluted in corn oil were added to one liquid and several dry flavor compositions. The catnip oil was purchased from the KooKy Cat Catnip Company, British Columbia, Canada. The liquid and dry flavor compositions were compared to their respective control flavor composition that did not contain nepetalactone. Comparisons T-W, showing the percent of catnip oil in the flavor composition and the resultant consumption ratio, are listed below in Table III. Comparisons T-V are dry flavor compositions, while W is a liquid flavor composition.

TABLE III

| | Flavor Composition | | |
|---|---|---|---|
| | (wt. % of flavor | Catnip Oil | |
| | composition in dry | (wt. % of flavor | |
| Comparison | food composition) | composition) | C.R. |
| T | 1.0 | 0.05 | 1.0 |
| | 1.0 | 0 | |
| U | 1.0 | 0.05 | 2.5 |
| | 1.0 | 0 | |
| V | 1.0 | 0.05 | 1.8 |
| | 1.0 | 0 | |
| W | 2.0 | 0.05 | 1.8 |
| | 2.0 | 0 | |

Comparisons T through W shows that about 0.05 weight percent catnip oil in the flavor composition can be effective in increasing the palatability of the cat food. Overall, the data shows that catnip oil is a positive palatability enhancer at the concentrations tested.

As a further test of the catnip palatability enhancer, several comparisons were performed using a catnip palatability enhancer in the absence of a flavor composition. In these examples, the catnip palatability enhancer was blended with cornstarch and compared to cornstarch alone. In all cases, the cornstarch or blend was coated onto a fat-coated kibble in an amount of 1% of the total weight of the dry food composition.

TABLE IV

| | | Amount of catnip | |
|---|---|---|---|
| | | palatability enhancer | |
| | Catnip Palatability | in coating composition | |
| Comparison | Enhancer | (wt %) | C.R. |
| X | Catnip powder | 3 | 1.5 |
| | | 0 | |
| Y | Catnip powder | 5 | 3.1 |
| | | 0 | |
| Z | Catnip powder | 10 | 8.2 |
| | | 0 | |
| AA | Catnip oil | 0.01 | 2.1 |
| | | 0 | |
| BB | Nepetalactone | 0.01 | −1.1 |
| | | 0 | |
| CC | Nepetalactone | 0.1 | 1.9 |
| | | 0 | |

Comparisons X through CC show that the catnip palatability enhancers are effective when applied as a coating in the absence of a flavor composition. In addition the catnip palatability enhancers are effective at similar concentrations in the presence or absence of a flavor composition.

While the invention has been described in terms of various specific embodiments, those skilled in the art will recognize that the invention can be practiced with modification within the spirit and scope of the claims.

1. An animal food composition comprising:
a basal animal food composition; and
a catnip palatability enhancer, wherein the catnip palatability enhancer comprises nepetalactone in the form of catnip, catnip oil, matatabi, an extract of matatabi, nepetalactone, an active analog of nepetalactone, or a combination comprising one or more of the foregoing nepetalactone forms, in an amount effective to enhance the palatability of the basal animal food composition.

2. The animal food composition of claim 1, wherein the basal food composition is a dry composition, a semi-dry composition, or a combination comprising one or more of the foregoing compositions.

3. The animal food composition of claim 1, wherein the catnip palatability enhancer is present in an amount of about 1×10⁻⁴ to about 10 weight percent of the total dry weight of the food composition.

4. The animal food composition of claim 1, wherein the catnip palatability enhancer is catnip or matatabi present at about 0.01 weight percent to about 1 weight percent of the total dry weight of the food composition.

5. The animal food composition of claim 4, wherein the catnip palatability enhancer is nepetalactone present at about 1×10⁻⁴ weight percent to about 0.01 weight percent of the total dry weight of the food composition.

6. The animal food composition of claim 1, wherein the catnip palatability enhancer is catnip oil or an extract of matatabi present at about 1×10⁻³ weight percent to about 0.01 weight percent of the total dry weight of the food composition.

7. The animal food composition of claim 1, wherein the catnip palatability enhancer is in the form of a coating comprising catnip or matatabi present at about 0.001 weight percent to about 0.1 weight percent of the total dry weight of the coating.

8. The animal food composition of claim 1, wherein the catnip palatability enhancer is in the form of a coating comprising nepetalactone at about 1×10⁻⁵ weight percent to about 0.01 weight percent of the total dry weight of the coating.

9. The animal food composition of claim 1, wherein the catnip palatability enhancer is in the form of a coating comprising catnip oil or an extract of matatabi at about 1×10⁻⁴ weight percent to about 0.01 weight percent of the total dry weight of the coating.

10. The animal food composition of claim 1, wherein the basal food composition is suitable for cats.

11. The animal food composition of claim 1, wherein the catnip palatability enhancer is in the form of a flavor composition comprising an additional flavoring agent.

12. The animal food composition of claim 11, wherein the additional flavoring agent is a vegetable flavoring, a meat flavoring, a cheese flavoring, an amino acid, a sugar, a phosphate salt, an organic acid, or a combination comprising one or more of the foregoing flavorings.

13. The animal food composition of claim 1, wherein at least a portion of the catnip palatability enhancer is dispersed in the basal food composition, disposed on the basal food composition in the form of a coating, or a combination thereof.

14. The animal food composition of claim 1, wherein the basal food composition further comprises a fat coating.

15. The animal food composition of claim 14, wherein the fat coating comprises at least a portion of the catnip palatability enhancer.

16. A method of increasing the palatability of an animal food composition, the method comprising:
incorporating a catnip palatability enhancer in a basal animal food composition, wherein the catnip palatability enhancer comprises nepetalactone in he form of catnip, catnip oil, matatabi, an extract of matatabi, nepetalactone, an active analog of nepetalactone, or a combination comprising one or more of the foregoing nepetalactone forms in an amount effective to enhance the palatability of the basal animal food composition.

17. A method for the manufacture of an animal food composition, comprising:
coating a basal animal food composition with at least a portion of a catnip palatability enhancer composition comprising nepetalactone in the form of catnip, catnip oil, matatabi, an extract of matatabi, nepetalactone, an active analog of nepetalactone, or a combination comprising one or more of the foregoing nepetalactone forms, wherein the total amount of the catnip palatability enhancer composition is effective to enhance the palatability of the basal animal food composition.

18. The method of claim 17, wherein the catnip palatability enhancer is in the form of a flavor composition comprising a fat and/or an additional flavoring agent.

19. A flavor composition for a cat food composition, the flavor composition comprising:
a catnip palatability enhancer comprising nepetalactone, wherein the catnip palatability enhancer is catnip; catnip oil; matatabi, an extract of matatabi; nepetalactone, its stereoisomers, and its derivatives; or a combination of one or more of the foregoing palatability enhancers, and
a flavoring.

20. The flavor composition of claim 23, wherein the catnip palatability enhancer is present at about 0.0001 weight percent to about 99 weight percent of the total dry weight of the flavor composition.
